(19) United States
(12) Patent Application Publication
(10) Pub. No.: US 2024/0143645 A1
(43) Pub. Date: May 2, 2024

(54) ITEM ANALYSIS AND LINKING ACROSS MULTIPLE MULTIMEDIA FILES

(71) Applicants: Getac Technology Corporation, New Taipei City (TW); WHP Workflow Solutions, Inc., North Charleston, SC (US)

(72) Inventors: Muhammad ADEEL, Edina, MN (US); Thomas GUZIK, Edina, MN (US)

(21) Appl. No.: 17/978,870

(22) Filed: Nov. 1, 2022

(51) Int. Cl. G06F 16/45; G06F 16/487

(52) U.S. Cl. CPC G06F 16/45; G06F 16/487

(57) ABSTRACT

A new multimedia file that includes multiple video frames is received. A determination is made as to whether a set of one or more machine-learning models was previously applied to a related multimedia file to identify at least one unique item of interest in the related multimedia file. In response to the set of one or more machine-learning models being previously applied to the related multimedia file, the set of one or more machine-learning models may be applied to the multiple video frames of the new multimedia file to at least identify the at least one unique item of interest in the new multimedia file. In response to no machine-learning model being previously applied to the related multimedia file, a new set of one or more machine-learning models may be applied to the new multimedia file to identify one or more unique items of interest in the new multimedia file.

### BACKGROUND

Law enforcement officers generally carry multiple body-worn electronic devices as they perform their law enforcement functions. For example, law enforcement agencies are increasingly mandating that their law enforcement officers carry and use portable recording devices to record audiovisual recordings of their interactions with the public. The recordings may serve to protect the public from improper policing, as well as protect law enforcement officers from false allegations of police misconduct. By using such portable recording devices, law enforcement officers may capture a significant amount of video data in the course of any given day. Given the large amount of such video content, it is often very tedious and time-consuming for a law enforcement agency to sift through video content to identify items or persons of interest that are relevant to an incident and/or associated with other items of interest. Further, since video content may become the subject of great interest to the public, the courts, adverse parties, investigators, and/or the law enforcement agencies themselves, the unintentional failure by law enforcement agencies to identify and disclose all video content that may contain items or persons of interest that are relevant to an incident may result in bad publicity and/or legal liabilities for a law enforcement agency.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 illustrates an example architecture that provides an environment for analyzing and linking items of interest across multiple multimedia files.

FIG. 2 illustrates an example relational diagram of relationships between various items of interest that appear in multiple multimedia files that are related to an incident.

FIG. 3 illustrates an example relational diagram of relationships between items of interest that appear in multiple multimedia files that are associated with related incidents.

FIG. 4 is a block diagram showing various components of a content management platform that supports item analysis and linking across multiple multimedia files.

FIG. 5 illustrates an example user interface page that enables a user to select specific items of interest to be linked.

FIG. 6 is a flow diagram of an example process of tracking an item of interest across multiple multimedia files.

FIG. 7 is a flow diagram of an example process for selectively applying machine-learning models to video frames of multimedia files associated with an incident.

FIGS. 8a and 8b illustrate a flow diagram of an example process for linking multiple items of interest that appear in multiple multimedia files.

### DETAILED DESCRIPTION

This disclosure is directed to techniques for identifying related items of interest in multiple multimedia files, such that the specific items of interest and/or specific multimedia files may be linked together in an item link database. The items of interest may include specific law enforcement officers, specific suspects, specific witnesses, specific persons of interest, specific vehicles, specific weapons, and/or so forth whose presence are captured in the multiple multimedia files. The multiple multimedia files may include multimedia files from various sources. For example, such multimedia files may include multimedia files that are captured by the portable recording devices carried by law enforcement officers (e.g., bodycams), captured by dashboard cameras present in law enforcement vehicles, captured by stationary law enforcement monitoring cameras positioned in geographical areas, submitted or obtained from third-party non-law enforcement entities, such as private businesses or residences, and/or so forth. The items of interest may be analyzed and linked to other items of interest based on similar appearances to other items of interest, their association with a specific incident, appearance in a multimedia file with other items of interest, appearance in a multimedia file that is associated with an incident or another related incident, and/or so forth. As used herein, an item of interest may refer to both an item of interest as well as a person of interest. In some embodiments, the incidents may include incidents that are resulted in the dispatch of law enforcement officers. The related items of interest and/or multimedia files may be linked together via metadata that is stored in an item link database of a content management platform. The content management platform may be a video storage and retrieval platform that is operated to store multimedia files, as well as provide multimedia files that capture specific incidents and/or are related to other specific items of interest.

In various embodiments, the content management platform may provide multimedia files in response to various queries based on the link data stored in the item link database. For example, the queries may include a query for all multimedia files related to a specific incident that captures a specific item of interest, a query for all multimedia files that captures a specific item of interest during a specific time period, a query for one or more unique items of interest that are associated with a particular item of interest in relation to a specific incident, etc.

Thus, by leveraging metadata that links multiple items of interest that are captured in multiple multimedia files as well as the linking the multiple multimedia files, a content management platform may efficiently retrieve multiple multimedia files that include one or more items of interest. The retrieved multimedia files may be provided for law enforcement or judicial evidentiary use, such that the multimedia files may help law enforcement officers to locate suspects and solve cases. The techniques described herein may be implemented in a number of ways. Example implementations are provided below with reference to the following figures.

### Example Architecture

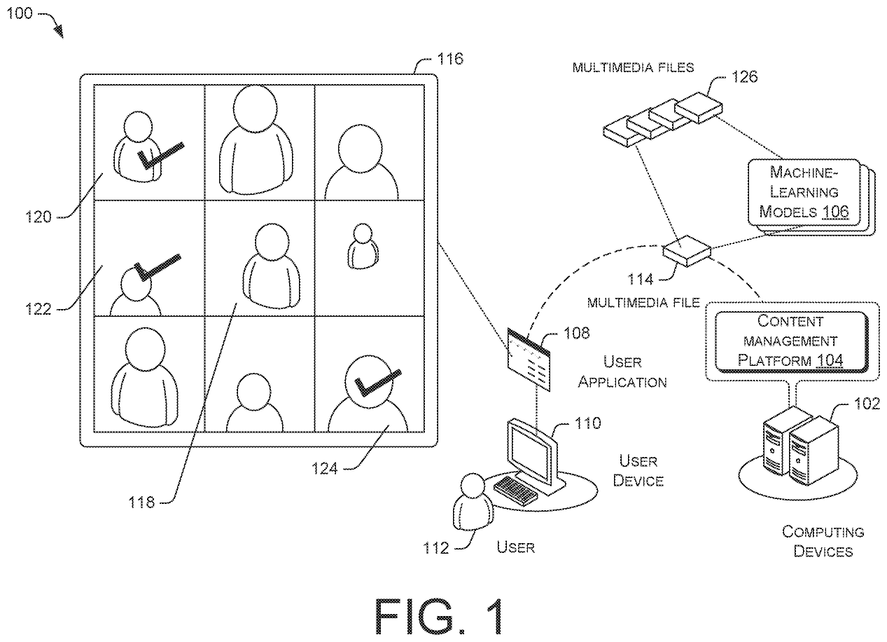

FIG. 1 illustrates an example architecture 100 that provides an environment for linking items of interest across multiple multimedia files. The environment may include one or more computing devices 102 that support a content management platform 104. The content management platform 104 may include functions that enable a user to perform various data processing operations on data assets, such as multimedia files. The multimedia files may be data files that include video data and audio data. The data processing operations may include accessing (e.g., playback), labeling, classification, redaction, analysis, and/or so forth. The multiple multimedia files may include multimedia files from various sources. For example, such multimedia files may include multimedia files that are captured by the portable recording devices carried by law enforcement officers (e.g., bodycams), captured by dashboard cameras present in law enforcement vehicles, captured by stationary law enforcement monitoring cameras positioned in geographical areas, submitted or obtained from third-party non-law enforcement entities, such as private businesses or residences, and/or so forth. In the context of law enforcement, the content management platform 104 may enable such data processing operations to be performed on evidentiary or law enforcement activity data that includes audio files and data files.

In various embodiments, the content management platform 104 may be capable of apply one or more machine-learning models 106 to a multimedia file associated with an incident to identify unique items of interest captured in the multimedia file. In some instances, the content management platform 104 may apply a single machine-learning model to the video frames of the multimedia file to detect various items of interest in a multimedia file. For example, the single machine-learning model may be trained to detect various items that include specific human faces, specific human body profiles, specific kinds of weapons, specific vehicles, and/or so forth. In other instances, the content management platform 104 may apply multiple machine-learning models to a multimedia file to detect various items of interest captured in the multimedia file. In such instances, each of the multiple machine-learning models 106 may be trained to detect a particular type of object in a multimedia file. For example, one of the machine-learning models may be trained to detect specific human faces that are captured in the video frames of a multimedia file. In another example, another one of the machine-learning models may be trained to detect specific human shape profiles that are captured in the video frames of a multimedia file. In an additional example, a third of the machine-learning models may be trained to detect specific kinds of weapon, such as a gun, that is captured in the video frames of a multimedia file. In yet another example, a fourth of the machine-learning models may be trained to detect vehicle license plates that are captured in the video frames of a multimedia file.

The content management platform 104 may provide various user interface pages for a user to interact with the platform via a remote application, such as the user application 108 that is executing on a user device 110. The various user interface pages may be presented via one or more user interface pages that are generated by the content management platform 104. The user application 108 may be a web browser or a dedicated thin-client application. The user device 110 may communicate with the content processing engine over a network. The network may be the Internet, a local area network (LAN), a wide area network (WAN), a cellular network, and/or some other network. In various embodiments, the user interface pages may be presented via one or more web pages that are generated by the content management platform 104. For example, the web pages may be in the form of HyperText Markup Language (HTML) documents, in which the documents may include text content, images, multimedia content, cascade style sheets (CSS), and/or scripts. In such embodiments, the content management platform 104 may use an application server that supports server-side scripting via multiple scripting languages, such as Active Server Pages (ASP), Hypertext Preprocessor (PHP), JavaScript, and other scripting languages to support the dynamic generation of web pages that presents output and receives input from a user via the user application 108.

In some embodiments, a user 112 may use the user application 108 to select a particular set of one or more machine-learning models to detect items of interest in a multimedia file, such as the multimedia file 114. For example, by browsing one or more video frames of the multimedia file using a user interface page provided by the user application 108, the user 112 may select the single machine-learning model that is trained to detect various items to process the multimedia file. In another example, the user 112 may select a set of machine-learning models that include a machine-learning model that detects specific human faces, a machine-learning model that detects specific weapons, and a machine-learning that detects vehicle license plates to process the multimedia file 114.

In some instances, the content management platform 104 may further use the user application 108 to prompt the user 112 to analyze the various items that are identified by the one or more machine-learning models from multimedia files. For example, the content management platform 104 may use an example user interface page 116 to present an image 118 of a unique item of interest (e.g., a face of a particular person) to the user 112 that is identified by one or more machine-learning models from the multimedia file 114. The user interface page 116 may be further used by the content management platform 104 to present one or more additional images of at least one additional object as captured in the multimedia file. The additional images may be identified by the one or more machine-learning models as being the closest matches to the image of the unique item of interest. For example, each of the additional images may be an image that is identified by a machine-learning model as being a potential match to the image of the unique item of interest (e.g., the additional images potentially being faces of the particular person), but whose match probability failed to meet a match probability threshold.

The content management platform 104 may use the example user interface page 116 to prompt the user 112 to use user interface pages to indicate to the content management platform which of the potential matches are actual images of the unique item of interest. For example, after reviewing the additional images, the user 112 may use the user interface pages to select images 120-124 as actual matches to the image 118. Following such user input from the user 112, the content management platform 104 may store item visual data for the item of interest that includes the image of the unique item of interest and the one or more images that are selected as matching images. Additionally, the user 112 may use the user interface pages to input item label information for the item of interest depicted in the images 118 and 120-124. The item label information may include information that uniquely identifies the item of interest, such as an item name, an item description, additional notes regarding the items, and/or so forth. The item label information for an item of interest may include information that is manually generated by the user 112 and/or information that the user 112 accesses and retrieves from a record management system (RMS). For example, the RMS may be an online law enforcement database that is maintained by or on behalf of a law enforcement agency.

In this way, by using the set of one or more machine learning models and/or interacting with the user 112 to refine the item visual data for various unique items, the content management platform 104 may identify and label multiple items of interest captured in the multimedia file 114. For example, the multiple items of interest may include specific law enforcement officers, specific suspects, specific witnesses, specific persons of interest, specific vehicles, specific weapons, and/or so forth.

The content management platform 104 may apply an item tracking algorithm to the multimedia file 114 to track the appearance of each unique item of interest in the video frames of the multimedia file. The tracking information for each appearance of the item of interest captured in the multimedia file may include item label information stored for the item of interest, the video frame numbers of the video frames in which the item of interest appears, a start timestamp and an end time stamp for each appearance of the item of interest captured in the multimedia file, and/or so forth. Each of the time stamps may include time information and date information.

In some scenarios, the content management platform 104 may receive one or more additional multimedia files 126 that are related to the multimedia file 114. In some instances, a multimedia file may be related to the multimedia file 114 because it has been labeled by law enforcement officers or other custodians of the multimedia file as capturing the same incident as the multimedia file 114. In other instances, a multimedia file may be related to the multimedia file 114 because the geolocation metadata associated with the multimedia file indicates that at least a portion (e.g., one or more video frames) of the multimedia file is captured within a predetermined distance of a geolocation at which at least a portion (e.g., one or more video frames) of the multimedia file 114 is captured. In such instances, each of the multimedia files 126 and the multimedia file 114 may be associated with geolocation metadata that is provided by a geolocation device (e.g., a global positioning system (GPS) device or on-board GPS module). The geolocation device may store a geolocation of the recording device (e.g., a camera) that captured the multimedia file into the geolocation metadata as a recording of the multimedia file is started, then continuously or periodically store additional geolocations of the recording device into the geolocation metadata as the recording of the multimedia file continues until the recording of the multimedia file is stopped. For example, a multimedia file that is captured by a dashboard camera on a vehicle that is traveling in an area may be determined by the content management platform 104 to be related to the multimedia file 114 because that geolocation metadata of the multimedia file indicates that at least a portion of the multimedia file is captured within a predetermined distance of a particular geolocation at which at least a portion of the multimedia file 114 is captured. This may be the case even though a majority of the multimedia file was not captured within the predetermined distance of the particular geolocation.

Thus, because the one or more additional multimedia files 126 are related to the multimedia file 114, the content management platform 104 may apply the specific set of one or more machine-learning models that were previously applied to the multimedia file 114 to the one or more related multimedia files 126. The specific set of one or more machine-learning models may be applied based on the item visual data of the unique items of interest that were identified in the multimedia file 114. For example, the item visual data of the unique items of interest may serve as training data for further training one or more corresponding machine-learning models in the specific set such that the item image detection performed by the specific set of machine-learning models may be improved. Accordingly, in some instances, the specific set of machine-learning models may identify one or more identical items of interest that were previously identified in the multimedia file 114 further in at least one of the related multimedia file 126.

Subsequently, for each of the related multimedia files 126 in which at least one identical item of interest is detected, the content management platform 104 may apply an item tracking algorithm to the multimedia file to track the appearance of each unique item of interest in the video frames of the multimedia file. The tracking information for each appearance of the item of interest in the multimedia file may include item label information stored for the item of interest, the video frame numbers of the video frames in which the item of interest appears, a start timestamp and an end time stamp for each appearance of the item of interest in the multimedia file, and/or so forth. In some embodiments, the item label information for a unique item of interest may be propagated automatically by the content management platform 104 based on the item label information stored in association with the multimedia file 114. However, in some instances, the application of the specific set of one or more machine-learning models to the related multimedia files 126 may also result in the detection of new unique items in one or more of the multimedia files 126 that are not present in the multimedia file 114. For such new unique items of interest, the content management platform 104 may apply an item tracking algorithm in a similar to manner to generate tracking information for each new unique item of interest.

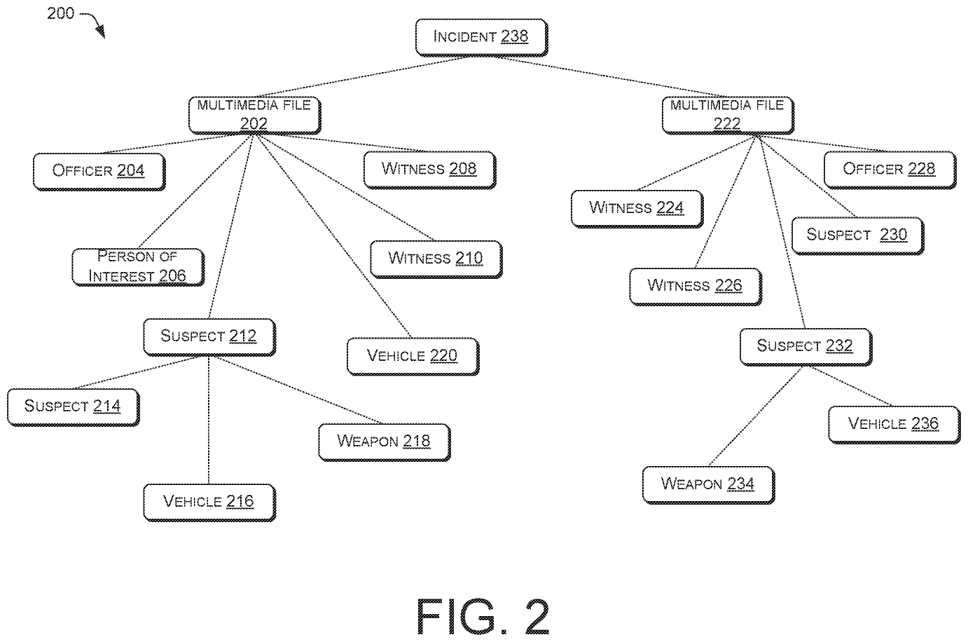

The content management platform 104 may further store metadata that links multiple unique items of interest that are identified as being present in one or more multimedia files in an item link database. For example, as shown in FIG. 2, a multimedia file 202 may include multiple items of interest 204-220 that are linked together in a first example relationship tree. Likewise, a multimedia file 222 may include multiple items of interest 224-236 that are linked together in a second example relationship tree. However, it will be appreciated that the items of interest in each of the multimedia files 202 and 222 may be linked together in other ways. In one scenario, some of the items of interest may be identical in both multimedia files 202 and 222. For example, the same law enforcement officer, suspect, weapon, person of interest, witness, and/or vehicle may appear in both multimedia files.

Moreover, the content management platform 104 may store metadata that links multiple unique items of interest that appear in the multimedia file and one or more related multimedia files in the item link database. In one example, the multimedia files 202 and 222 may be associated with the same incident 238. Accordingly, the multimedia files 202 and 222 may be linked together. Further, any of the unique items of interest captured in the multimedia file 202 may be linked with other unique items of interest in the multimedia file 222. However, the multimedia files 202 and 222 may be related in other ways, such as when at least a portion of the multimedia file 202 is captured within a predetermined distance of at least a portion of the multimedia file 222.

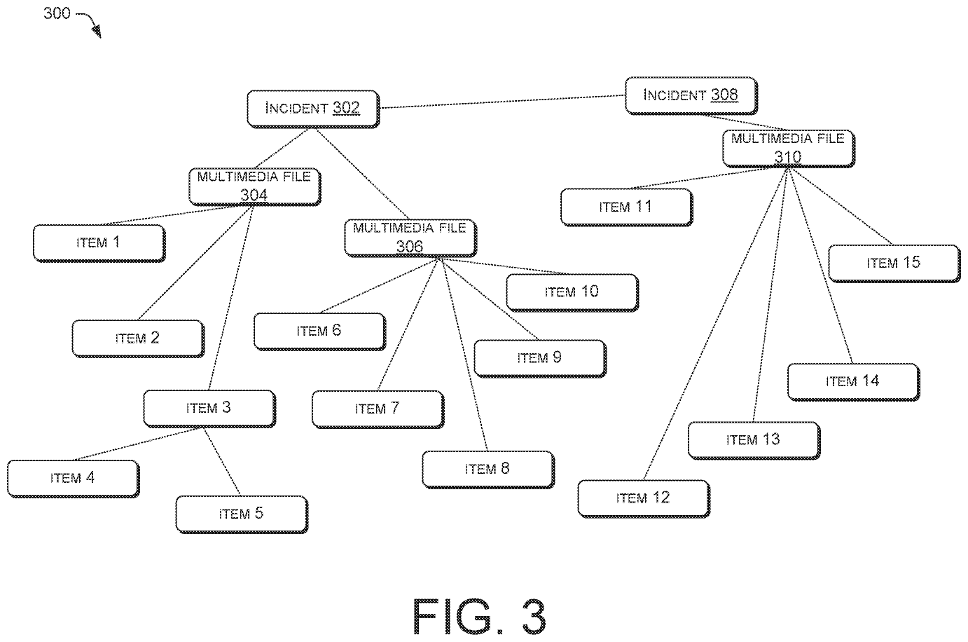

Additionally, the content management platform 104 may store metadata that links multiple multimedia files associated with multiple incidents when the multiple incidents are identified as being related incidents or associated with at least one common unique item of interest in the item link database. For example, as shown in FIG. 3, an incident 302 may be captured by a multimedia file 304 and a multimedia file 306. Likewise, an incident 308 may be captured by the multimedia file 310. As further shown in FIG. 3, each of the multimedia files 304, 306, and 308 may include items of interest that are captured by the multimedia files. The content management platform 104 may receive a user input from the user 112 via a user interface page that indicates that incidents 302 and 308 are related incidents. Alternatively, an incident classification algorithm of the content management platform 104 may have automatically classified the incidents 302 and 308 based on one or more parameters of the incidents. For example, the incidents 302 and 308 may be of the same crime type, share common incident characteristics (e.g., occurred in a similar geographic area, at the same time of day, by the same weapon, etc.), or crimes known to be committed by the same person, incidents for which the same law enforcement officer responded, and/or so forth. Accordingly, the incidents 302 and 308 may be linked together, and the multimedia files 304, 306, and 308 may be linked together. Further, any of the unique items of interest captured in the multimedia files 304, 306, and 308 may be linked together.

In another scenario, some of the items of interest may be present in more than one of the multimedia files 304, 306, and 308. For example, the same law enforcement officer, suspect, weapon, person of interest, witness, and/or vehicle may be present in more than one multimedia file. Accordingly, multiple multimedia files and/or items of interest included in them may also be linked together solely based on the basis that the multiple multimedia files contain at least one common item of interest.

In various embodiments, the content management platform 104 may automatically link items of interest together that are present in one multimedia file or multiple multimedia files based on the various relationships illustrated with respect to FIGS. 2 and 3. Alternatively, the content management platform 104 may use a user interface page to prompt the user 112 as to whether various items that are present in one multimedia file or multiple multimedia files are to be linked together in various combinations. Accordingly, the content management platform 104 may link one or more of the unique items of interest together based on input from the user 112. In this way, the items of interest captured in the multimedia file 114 and the multimedia files 126, as well as the multimedia files themselves, may be linked together in various combinations in different scenarios.

The metadata stored by the content management platform 104 may be further used by the platform to provide multimedia files that are relevant to various queries. Such queries may be inputted by a user (e.g., the user 112) via a user interface page that is accessible via a user application (e.g., the user application 108). For example, the queries may include a query for all multimedia files related to a specific incident that captures a specific item of interest, a query for all multimedia files that captures a specific item of interest during a specific time period, a query for one or more unique items of interest that are associated with a particular item of interest in relation to a specific incident, etc. Other queries may include a query for one or more unique items of interest that are associated with a particular unique item of interest, a query for one or more unique items of interest that are associated with a particular unique item of interest in relation to a specific incident, and/or so forth. In response to such queries, the content management platform 104 may provide information on the relevant items of interest based on the metadata stored in the item link database. The information provided on a relevant item of interest may include an image of the item of interest that is extracted from a corresponding multimedia file, the item label information, links to the multimedia files in which the item of interest appears, the item tracking information of the item of interest with respect to the multimedia files in which the item of interest appears, and/or so forth.

In some embodiments, the user 112 may initiate a redaction of an identified item of interest from video frames of corresponding multimedia files. In such embodiments, the content management platform 104 may apply use the item tracking information to identify the video frames in which the item appears, and then apply a redaction algorithm to render the appearances of the item in the one video frames visually unrecognizable. For example, a user (e.g., the user 112) may initiate the redaction of the item of interest in one or more multimedia files via a user interface page that is accessible via a user application (e.g., the user application 108). In such embodiments, the redaction algorithm may apply a pixelation effect, a blurring effect, an opaque overlay effect, and/or some other obfuscation effect to the appearances of the item of interest in video frames. In some instances, the user interface screen control may provide further options that may be selected for performing additional data processing operations on item of interest, such as storing additional information for the item of interest, correcting the item label information for the item of interest, removing or modifying the links between the item of interest and other items of interest, and/or so forth.

### Example Content Management Platform Components

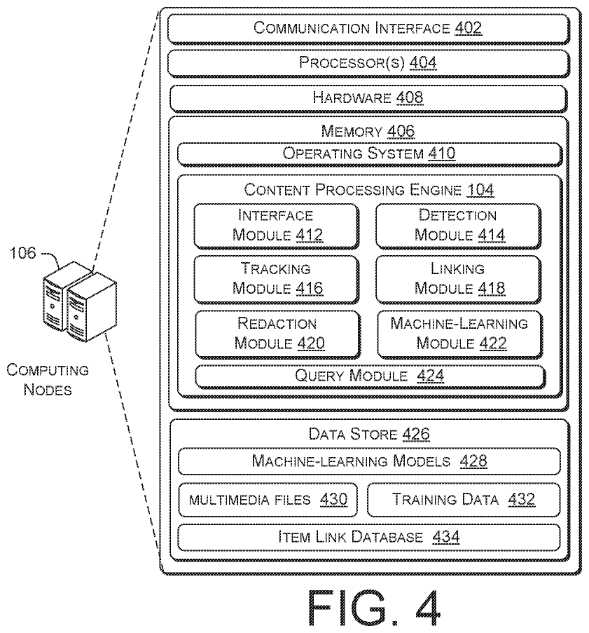

FIG. 4 is a block diagram showing various components of a content management platform that supports item analysis and linking across multiple multimedia files. The computing devices 102 may provide a communication interface 402, one or more processors 404, memory 406, and hardware 408. The communication interface 402 may include wireless and/or wired communication components that enable the devices to transmit data to and receive data from other networked devices. The hardware 408 may include additional hardware interface, data communication, or data storage hardware. For example, the hardware interfaces may include a data output device (e.g., visual display, audio speakers), and one or more data input devices. The data input devices may include, but are not limited to, combinations of one or more of keypads, keyboards, mouse devices, touch screens that accept gestures, microphones, voice or speech recognition devices, and any other suitable devices.

The memory 406 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms.

The processors 404 and the memory 406 of the computing devices 102 may implement an operating system 410. In turn, the operating system 410 may provide an execution environment for the content management platform 104. The operating system 410 may include components that enable the computing devices 102 to receive and transmit data via various interfaces (e.g., user controls, communication interface, and/or memory input/output devices), as well as to process data using the processors 404 to generate output. The operating system 410 may include a presentation component that presents the output (e.g., display the data on an electronic display, store the data in memory, transmit the data to another electronic device, etc.). Additionally, the operating system 410 may include other components that perform various additional functions generally associated with an operating system.

The content management platform 104 may include an interface module 412, a detection module 414, a tracking module 416, a linking module 418, a redaction module 420, a machine-learning module 422, and a query module 424. The modules may include routines, program instructions, items, and/or data structures that perform particular tasks or implement particular abstract data types. The memory 406 may also include a data store 426 that is used by the content management platform 104.

The interface module 412 may include functionalities for streaming multimedia files to a user application (e.g., user application 108) on a remote user device, such as the user device 110. For example, the interface module 412 may support media player functionalities that enable selection, playback, stop, pause, fast forward, rewind, video frame preview, video frame selection, and/or so forth for multimedia files. In this way, a user of the user application may use the functionalities of the interface module 412 to select various multimedia files stored in a content data store accessible to the content management platform 104 for playback and processing. The content data store may include a localized data store, a remote network data store, and/or so forth. Additionally, the interface module 412 may provide the user application with access to various user interface pages that enable the user to perform data processing operations with respect to the multimedia files. Accordingly, the interface module 412 may receive various control inputs that are inputted by a user at the user application. In turn, the interface module 412 may perform corresponding operations with respect to the multimedia files based on user inputs, or direct other modules of the content management platform 104 to perform operations based on the user inputs.

The detection module 414 may be activated to apply various machine-learning model that is trained to detect items of interest with respect to video frames of multimedia files. The various machine-learning models may include multiple machine-learning models in which each is trained to detect an item of a specific item type. For example, the various machine-learning models may include a machine-learning model specifically trained to detect faces, a machine-learning model that is specifically trained to detect human shapes, a machine-learning model that is specifically trained to detect license plates, a machine-learning model that is specifically trained to detect mobile device display screens, a machine-learning model that is specifically trained to detect a particular weapon (e.g., a gun), and/or so forth.

In some alternative embodiments, machine-learning models may also be trained to detect an item of the same type, but which differs in relative size in the video frames. For example, a first machine-learning model may be trained to detect faces in which each face has an area with a number of pixels that is equal to or higher than a pixel number threshold. In contrast, a second machine-learning model may be trained to detect faces in which each face has an area with a number of pixels that is lower than the pixel number threshold. Thus, the first machine-learning model may be trained to detect larger faces (e.g., closer faces) while the second machine-learning model may be trained to detect small faces (e.g., far away faces) as captured in video frames. Thus, when a user initiates the detection of an item in a multimedia file, the detection module 414 may apply multiple machine-learning models that detect items of the same type but different relative sizes to the video frame. In additional embodiments, the detection module 414 may be configured to apply a single machine-learning model that is trained to detect various items of interest to multimedia files.

In some instances, a machine-learning model may provide a confidence score that indicates a likelihood that the probable item corresponds to the analyzed image data of an image. In such instances, the detection module 414 may determine that an item of interest of a specific item type is detected when the confidence score is at or above a confidence score threshold. Conversely, the detection module 414 may determine that the item of interest of a specific item type is not detected in an image when the confidence score is below the confidence score threshold. However, for some images of items in which the confidence score is below the confidence score threshold but above a confidence score minimal cutoff threshold, the detection module 414 may present such images for manual analysis and selection as corresponding to an item of interest. In this way, the selected images may serve as additional item visual data. Such item visual data may be further used for training machine-learning models to recognize the item of interest.

Once an item of a specific item type is detected, the detection module 414 may superimpose an indicator on the video frame to show that the item of the specific item type is detected. For example, the indicator may include an outline shape that surrounds the image of the item, as well as present a text label that indicates the item type of the item. Other indicator examples may include changing a background color of the image, using a flashing effect on the image, or otherwise altering the appearance of the image in some manner to call attention to the image. In various embodiments, the detection module 414 may receive input of item label information and/or corrections of item label information for each of the items of interest that is detected.

In some embodiments, the one or more machine-learning models applied by the detection module 414 to a multimedia file may be dependent on whether the multimedia file is related to a multimedia file that was previously processed by the detection module 414. For example, if the metadata for a multimedia file to be processed by the detection module 414 indicates that the multimedia file is related to a previously processed multimedia file, the detection module 414 may automatically apply the same set of one or more machine-learning models that was applied to the previously processed multimedia file. However, if the metadata for the multimedia file does not indicate that the multimedia file is related to any previously processed multimedia files, the detection module 414 may apply a designated set of one or more machine-learning models to the multimedia file. The designated set may be a default set of the one or more machine-learning models or a particular set of one or more machine-learning models that are specifically selected for application to the multimedia file by a user via a user interface page provided by the detection module 414.

The tracking module 416 may be activated to track an item of a specific item type that is identified by a machine-learning model across multiple video frames. In some embodiments, the tracking may be performed using an item tracking algorithm that makes use of object pattern recognition. The object pattern recognition may reduce an image of the object to be tracked into a set of features. The object pattern recognition may then look for the set of features in the next video frame to track the object across multiple video frames. For example, the item tracking algorithm may be a target representation and localization algorithm, a filtering and data association algorithm, or some other comparable algorithm. For an item that is tracked across multiple video frames, the tracking module 416 may superimpose an indicator on each video frame to show that the object of the specific item type is being tracked across multiple video frames. For example, the indicator may include an outline shape that surrounds the image of the item, as well as present a text label obtained from the detection module 414 that indicates the item type of the object. This may result in the item being shown as being bounded by an outline shape with an item type label as the object moves around in a field of view as the multimedia file is being played back.

In other embodiments, the object pattern recognition may be fine-tuned to detect not only items of specific types, but also items of the specific types with specific feature attributes. For example, the object pattern recognition may be used to track the face of a particular person or a particular license plate across multiple video frames. In such embodiments, the tracking module 416 may provide additional user interface pages accessible via a user application, such as the user application 108, that enables users to select items with specific feature attributes for tracking across the multiple video frames. For example, the user interface pages may be used to independently track images of items of the same type but of different relative sizes in video frames. As each item of interest is tracked by the tracking module 416 across video frames of a multimedia file, the tracking module 416 may store tracking information for each item of interest. Accordingly, the tracking information for an item of interest may be subsequently used to locate video frames in a multimedia file that contains images of the item of interest.

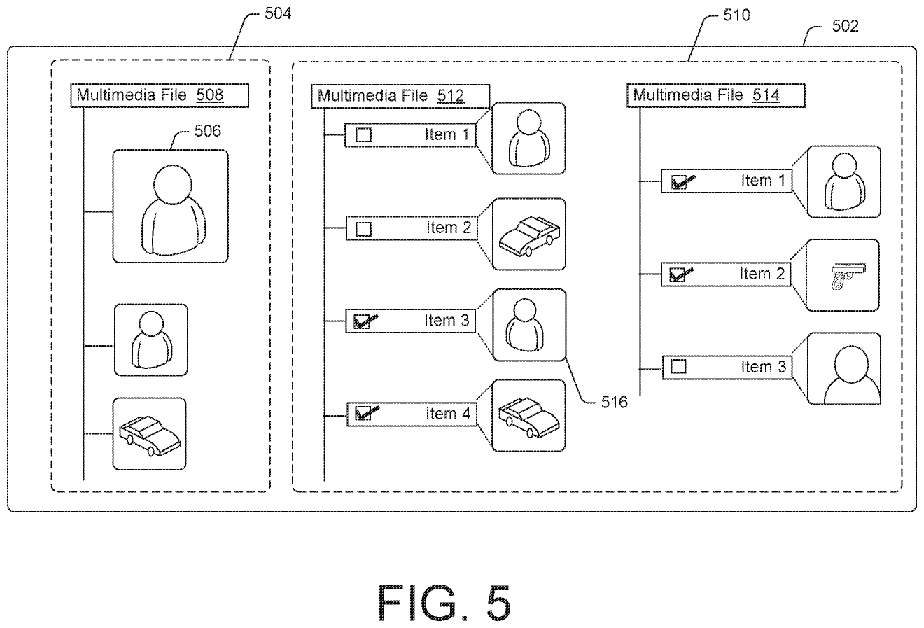

The linking module 418 may link items of interest that are located in various video files. In some embodiments, the linking may be performed automatically based on the appearance of the items of interest in related multimedia files (e.g., multimedia files that capture the same incident), in multimedia files that are associated with related incidents, and/or so forth. In other embodiments, the linking by the linking module 418 may be performed based on input that is provided by a user. For instance, FIG. 5 illustrates an example user interface page 502 that enables a user to select specific items of interest to be linked. As shown, the user interface page 502 may include a portion 504 that shows an item of interest 506 that is detected in a multimedia file 508. The user interface page 502 may further include a portion 510 that shows multimedia files that are related to the multimedia file 508, such as the multimedia files 512 and 514. For each of the multimedia files 512 and 514, the user interface page 502 may show information for each item of interest that is detected in the multimedia file. For example, the information for an item of interest may include an image of the item, the item label information, and/or so. Each of the items of the multimedia files 512 and 514 may be further provided with a checkbox (e.g., checkbox 516). Accordingly, the activation of a checkbox that is associated with an item may link the item to the item of interest 506. The linking between any two items of interest in one or more multimedia files may be stored as metadata in an item link database 434.

The redaction module 420 may be activated to redact the image of an item in a video frame that is identified via the detection module 414 and/or the tracking module 416. The redaction module 420 may redact the image of the item by applying a visual effect on the image of the item. For example, the visual effect may include a pixelation effect, a blurring effect, an opaque overlay effect, and/or some other obfuscation effect that renders the object in the image unrecognizable. In various embodiments, the visual effect may be a one-way effect that causes the loss of data from the image, such that the one-way effect is not reversible.

The machine-learning module 422 may be activated to train the various matching-learning models that are used for object detection. Each of the machine learning models may be trained via a model training algorithm. The model training algorithm may implement a training data input phase, a feature engineering phase, and a model generation phase. In the training data input phase, the model training algorithm may receive training data. For example, the training data set for training a particular machine-learning model to detect a specific item type may include positive training data in the form of object images that are labeled with the specific item type. However, in some instances, the training data set may include negative training data in the form of object images that are labeled with one or more other item types. During the feature engineering phase, the model training algorithm may pinpoint features in the training data. Accordingly, feature engineering may be used by the model training algorithm to figure out the significant properties and relationships of the input datasets that aid a machine learning model to distinguish between different classes of data.

During the model generation phase, the model training algorithm may select an initial type of machine learning algorithm to train a machine learning model using the training data. Following the application of a selected machine-learning algorithm to the training data to train a machine-learning model, the model training algorithm may determine a training error measurement of the machine-learning model. If the training error measurement exceeds a training error threshold, the model training algorithm may use a rule engine to select a different type of machine-learning algorithm based on a magnitude of the training error measurement to train the machine-learning model. The different types of machine learning algorithms may include a Bayesian algorithm, a decision tree algorithm, a support vector machine (SVM) algorithm, an ensemble of trees algorithm (e.g., random forests and gradient-boosted trees), an artificial neural network, and/or so forth. The training process is generally repeated until the training results fall below the training error threshold and the trained machine learning model is generated.

In some embodiments, the machine learning models for detecting an object of a specific item type may be trained using different sets of training data, such as images showing items of the same item type but with other object attributes that are different. These attributes may include size, color, texture, and/or so forth. For example, a first set of training data for training a first machine-learning model may include images of faces in which each face has an area with a number of pixels that is equal to or higher than a pixel number threshold. In contrast, a second set of training data for training a second machine-learning model may include faces in which each face has an area with a number of pixels that is lower than the pixel number threshold. In another example, a first machine-learning model may be trained to detect a specific vehicle type of a first color while a second machine-learning model may be trained to detect the specific vehicle of a second color (e.g., red trucks vs. blue trucks). In this way, multiple machine-learning models may be trained to detect items of the same item type, but with other object attributes that are different. In additional embodiments, the machine-learning module 422 may periodically retrain existing machine-learning models with new or modified training data sets. For example, a modified training data set for training a machine-learning model for the detection of an item of interest may include updated item visual data for the item of interest.

The query module 424 may receive various queries that are inputted via one or more user interface pages, in which the queries may be inputted by users, such as the user 112. In response, the query module 424 may provide information on related items of interest, related multimedia files, and/or so forth, based on the metadata stored in the item link database 434. For example, the queries may include a query for all multimedia files related to a specific incident that captures a specific item of interest, a query for all multimedia files that captures a specific item of interest during a specific time period, a query for one or more unique items of interest that are associated with a particular item of interest in relation to a specific incident, etc. The query module 424 may use the one or more user interface pages to present the information in response to the queries.

In some embodiments, the content management platform 104 may further include an access control function. The access control function may be used to ensure that only authorized users of the content management platform 104 are able to access the functionalities of the engine by submitting the correct user credentials via a user application, such as the user application 108. The data store 426 may store data that is processed and/or generated by the various modules of the content management platform 104. For example, the data that is stored in the data store 426 may include machine-learning models 428, multimedia files 430, training data 432, and an item link database 434. The multimedia files 430 may include original versions of multimedia files, multimedia files that have been marked up with metadata indicating detected items, items links, and/or so forth.

### Example Processes

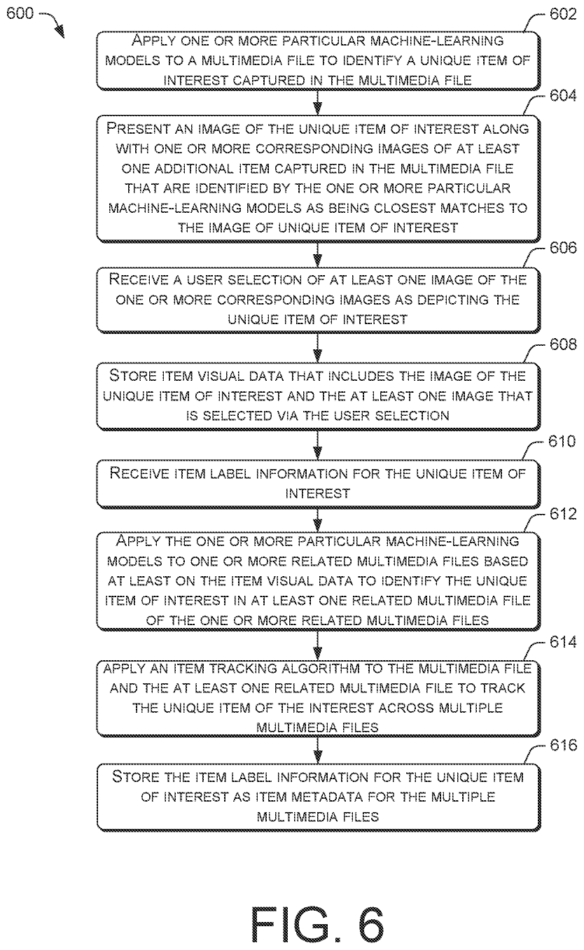

FIGS. 6-8 present illustrative processes 600-800 for analyzing and linking items of interest across multiple multimedia files. Each of the processes 600-800 is illustrated as a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, items, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes 600-800 are described with reference to the architecture 100 of FIG. 1.

FIG. 6 is a flow diagram of an example process 600 of tracking an item of interest across multiple multimedia files. At block 602, the content management platform 104 may apply one or more particular machine-learning models to a multimedia file to identify a unique item of interest captured in the multimedia file. At block 604, the content management platform 104 may present an image of the unique item of interest along with one or more corresponding images of at least one additional item captured in the multimedia file that are identified by the one or more particular machine-learning models as being closest matches to the image of the unique item of interest. For example, each of the additional images may be an image that is identified by a machine-learning model as being a potential match to the image of the unique item of interest (e.g., the additional images potentially being faces of the particular person), but whose match probability failed to meet a match probability threshold. The one or more corresponding images of at least one additional item may be presented via a user interface page.

At block 606, the content management platform 104 may receive a user selection of at least one image of the one or more corresponding images as depicting the unique item of interest. In various embodiments, the user selection of the at least one image may be received via the user interface page. At block 608, the content management platform 104 may store item visual data that includes the image of the unique item of interest and the at least one image that is selected via the user selection. At block 610, the content management platform 104 may receive item label information for the unique item of interest. The item label information may include information that uniquely identifies the item of interest, such as an item name, an item description, additional notes regarding the items, and/or so forth.

At block 612, the content management platform 104 may apply the one or more particular machine-learning models to the one or more related multimedia files based at least on the item visual data to identify the unique item of interest in at least one related multimedia file of the one or more related multimedia files. For example, the one or more particular machine-learning models may be further trained to identify the unique item of interest based on the item visual data that includes the at least one image that is selected via the user selection.

At block 614, the content management platform 104 may apply an item tracking algorithm to the multimedia file and the at least one related multimedia file to track the unique item of interest across multiple multimedia files. At block 616, the content management platform 104 may store the item label information for the unique item of interest as item metadata for the multiple multimedia files. In various embodiments, the process 600 may be repeated for multiple unique items of interest that are captured in the multimedia file and the one or more related multimedia files.

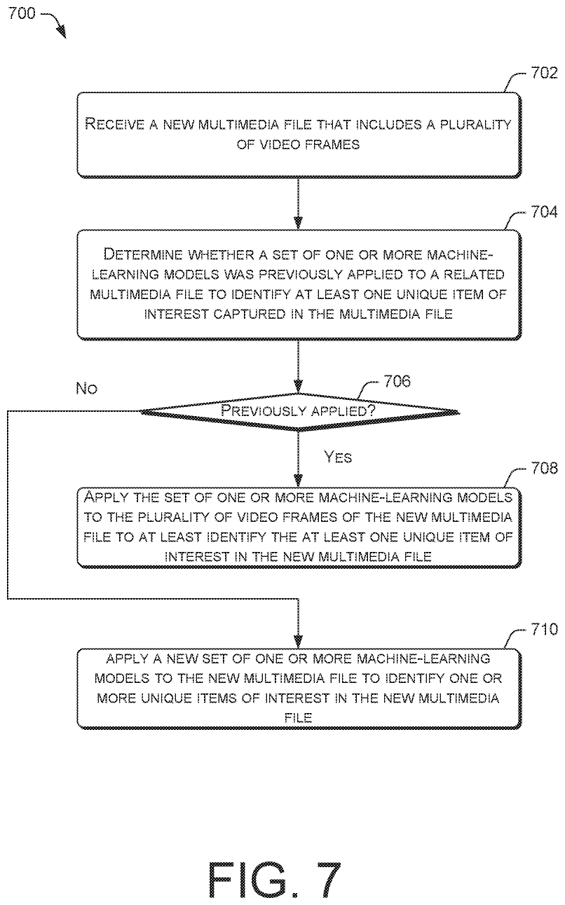

FIG. 7 is a flow diagram of an example process 700 for selectively applying machine-learning models to video frames of multimedia files associated with an incident. At block 702, the content management platform 104 may receive a new multimedia file that includes a plurality of video frames. At block 704, the content management platform 104 may determine whether a set of one or more machine-learning models was previously applied to a related multimedia file to identify at least one unique item of interest captured in the multimedia file. At decision block 706, if the set of one or more machine-learning models was previously applied (“yes” at decision block 706), the process 700 may proceed to block 708.

At block 708, the content management platform 104 may apply the set of one or more machine-learning models to the plurality of video frames of the new multimedia file to at least identify the at least one unique item of interest in the new multimedia file. However, if the set of one or more machine-learning models was not previously applied to a related multimedia file (“no” at decision block 706), the process 700 may proceed to block 710. In some instances, no machine-learning model may have been previously applied to any related multimedia files because no multimedia file related to the new multimedia file has yet been processed by the content management platform 104. In other instances, no machine-learning model may have been previously applied because the new multimedia file is not related to any previous multimedia files processed by the content management platform 104.

At block 710, the content management platform 104 may apply a new set of one or more machine-learning models to the new multimedia file to identify one more unique items of interest in the new multimedia file. The new set of one or more machine-learning models applied by the platform may be a default set of one or more machine-learning models or a set of one or more machine-learning models that are manually selected for application to the new multimedia file.

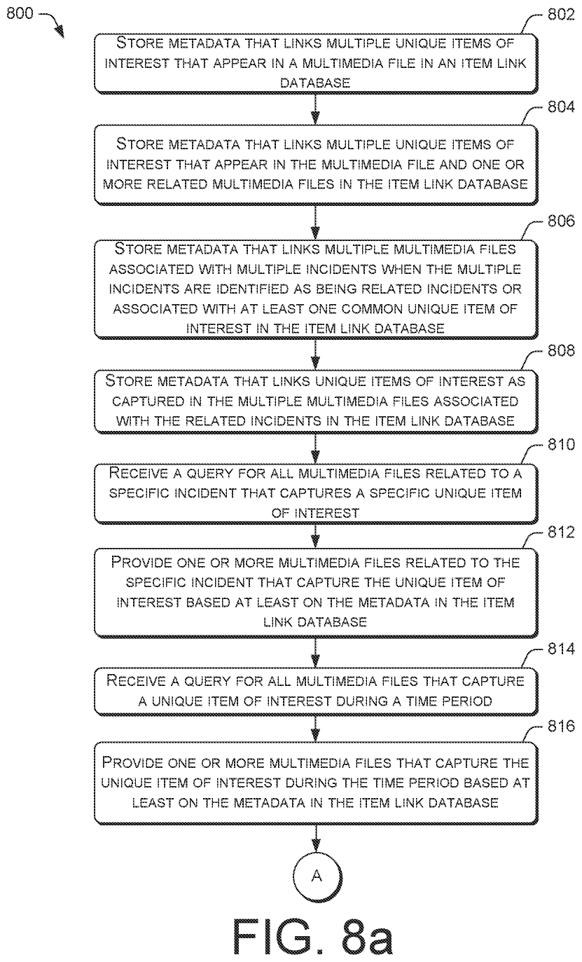

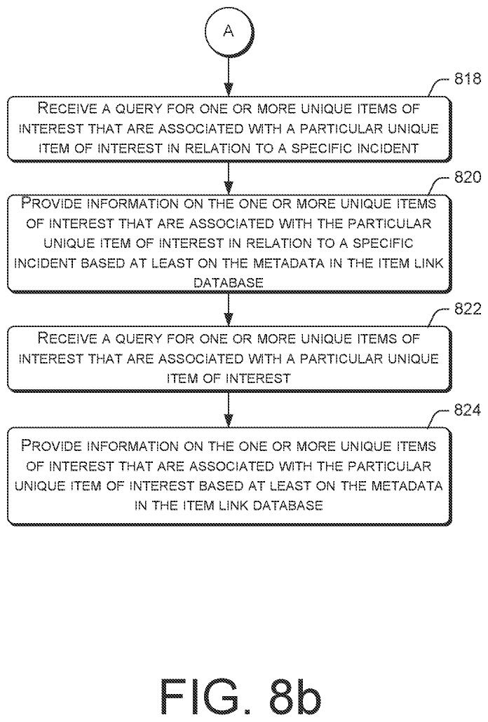

FIGS. 8a and 8b illustrate a flow diagram of an example process 800 for linking multiple items of interest that appear in multiple multimedia files. At block 802, the content management platform 104 may store metadata that links multiple unique items of interest that appear in a multimedia file in an item link database. At block 804, the content management platform 104 may store metadata that links multiple unique items of interest that appear in the multimedia file and one or more related multimedia files in the item link database. At block 806, the content management platform 104 may store metadata that links multiple multimedia files associated with multiple incidents when the multiple incidents are identified as being related incidents or associated with at least one common unique item of interest in the item link database. At block 808, the content management platform 104 may store metadata that links unique items of interest as captured in the multiple multimedia files associated with the related incidents in the item link database.

At block 810, the content management platform 104 may receive a query for all multimedia files related to a specific incident that captures a specific unique item of interest. At block 812, the content management platform 104 may provide one or more multimedia files related to the specific incident that capture the unique item of interest based at least on the metadata in the item link database. For example, the content management platform 104 may use a user interface page to provide information for the one or more multimedia files. The information may include a link to a data storage location where the one or more multimedia files are stored, the tracking information for the unique item of interest in each of the one or more multimedia files, and/or so forth.

At 814, the content management platform 104 may receive a query for all multimedia data files that capture a unique item of interest during a time period. At block 816, the content management platform 104 may provide one or more multimedia files that capture the unique item of interest during the time period based at least on the metadata in the item link database. For example, the one or more multimedia files may be provided based on the time stamps associated with the start and end time stamps for the unique item of interest. In some embodiments, the content management platform 104 may use a user interface page to provide information for the one or more multimedia files. The information may include a link to a data storage location where the one or more multimedia files are stored, the tracking information for the unique item of interest in each of the one or more multimedia files, and/or so forth.

At block 818, the content management platform 104 may receive a query for one or more unique items of interest that are associated with a particular unique item of interest in relation to a specific incident. At block 820, the content management platform 104 may provide information on the one or more unique items of interest that are associated with the particular unique item of interest in relation to a specific incident based at least on the metadata in the item link database. The information may include item label information for each unique item of interest, tracking information indicating where in multimedia files each unique item of interest appears, and/or so forth. The information may be presented by the content management platform 104 via a user interface page.

At block 822, the content management platform 104 may receive a query for one or more unique items of interest that are associated with a particular unique item of interest. At block 824, the content management platform 104 may provide information on the one or more unique items of interest that are associated with the particular unique item of interest based at least on the metadata in the item link database. The information may include item label information for each unique item of interest, tracking information indicating where in multimedia files each unique item of interest appears, and/or so forth. The information may be presented by the content management platform 104 via a user interface page.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. One or more non-transitory computer-readable media storing computer-executable instructions that upon execution cause one or more processors to perform acts comprising:
receiving a new multimedia file that includes a plurality of video frames;
determining whether a set of one or more machine-learning models was previously applied to a related multimedia file to identify at least one unique item of interest in the related multimedia file;
in response to determining that the set of one or more machine-learning models was previously applied to the related multimedia file, applying the set of one or more machine-learning models to the plurality of video frames of the new multimedia file to at least identify the at least one unique item of interest in the new multimedia file; and
in response to determining that no machine-learning model was previously applied to the related multimedia file, applying a new set of one or more machine-learning models to the new multimedia file to identify one or more unique items of interest in the new multimedia file.

2. The one or more non-transitory computer-readable media of claim 1, wherein the new set includes a default set of one or more machine-learning models or a manually selected set of one or more machine-learning models.

3. The one or more non-transitory computer-readable media of claim 1, wherein the related multimedia file is a first multimedia file that captures an identical incident as the new multimedia file, or a second multimedia file in which at least a portion of the second multimedia file is captured within a predetermined distance of a geolocation at which at least a portion of the new multimedia file is captured.

4. The one or more non-transitory computer-readable media of claim 1, wherein the acts further comprise:
applying the set of one or more machine-learning models to a multimedia file to identify a unique item of interest captured in the multimedia file;
presenting an image of the unique item of interest along with one or more corresponding images of at least one additional item of interest captured in the multimedia file that are identified by the set of one or more machine-learning models as being closest matches to the image of the unique item of interest;
receiving a user selection of at least one image of the one or more corresponding images as depicting the unique item of interest; and
storing item visual data that includes the image of the unique item of interest and the at least one image that is selected via the user selection,
wherein applying the set of one or more machine-learning models includes applying the set of one or more machine-learning models following training based on the item visual data to identify the unique item of interest in the new multimedia file.

5. The one or more non-transitory computer-readable media of claim 4, wherein a corresponding image of an additional item is determined to be a closest match to the image when a confidence score indicating whether the corresponding image is of the unique item of interest is below a confidence score threshold but above a confidence score minimal cutoff threshold.

6. The one or more non-transitory computer-readable media of claim 1, wherein the acts further comprise:
receiving item label information for a unique item of interest captured in the related multimedia file; and
storing the item label information as metadata for the related multimedia file and the new multimedia file when the unique item of interest is identified in the new multimedia file.

7. The one or more non-transitory computer-readable media of claim 6, wherein the acts further comprise applying an item tracking algorithm to the new multimedia file and the related multimedia file to track the unique item of interest in the new multimedia file and the related multimedia file.

8. The one or more non-transitory computer-readable media of claim 7, wherein the acts further comprise redacting the unique item of interest from at least one of the new multimedia file or the related multimedia file based at least on tracking information for the unique item of interest provided by the item tracking algorithm.

9. The one or more non-transitory computer-readable media of claim 1, wherein the acts further comprise at least one of:
storing, in an item link database, first metadata that links multiple unique items of interest that appear in the new multimedia file;
storing, in the item link database, second metadata that links multiple unique items of interest that appear in the new multimedia file and one or more related multimedia files;
storing, in the item link database, third metadata that links multiple multimedia files associated with multiple incidents when the multiple incidents are identified as being related incidents or associated with at least one common unique item of interest; or
storing, in the item link database, fourth metadata that links unique items of interest as captured in the multiple multimedia files associated with the related incidents.

10. The one or more non-transitory computer-readable media of claim 9, wherein the acts further comprise:
receiving a query for all multimedia files related to a specific incident that captures a particular unique item of interest during a time period; and
providing one or more multimedia files related to the specific incident that captures the particular unique item of interest based at least on metadata in the item link database.

11. The one or more non-transitory computer-readable media of claim 9, wherein the acts further comprise:
receiving a query for all multimedia files that capture a particular unique item of interest during a time period; and
providing one or more multimedia files that capture the particular unique item of interest during the time period based at least on metadata in the item link database.

12. The one or more non-transitory computer-readable media of claim 9, wherein the acts further comprise:
receiving a query for one or more unique items of interest that are associated with a particular unique item of interest in relation to a specific incident; and
providing information on the one or more unique items of interest that are associated with the particular unique item of interest in relation to a specific incident based at least on metadata in the item link database.

13. The one or more non-transitory computer-readable media of claim 9, wherein the acts further comprise:
receiving a query for one or more unique items of interest that are associated with a particular unique item of interest; and
providing information on the one or more unique items of interest that are associated with the particular unique item of interest based at least on metadata in the item link database.

14. A system, comprising:
one or more processors; and
memory including a plurality of computer-executable components that are executable by the one or more processors to perform a plurality of actions, the plurality of actions comprising:
receiving a new multimedia file that includes a plurality of video frames;
determining whether a set of one or more machine-learning models was previously applied to a related multimedia file to identify at least one unique item of interest in the related multimedia file;
in response to determining that the set of one or more machine-learning models was previously applied to the related multimedia file, applying the set of one or more machine-learning models to the plurality of video frames of the new multimedia file to at least identify the at least one unique item of interest in the new multimedia file; and
in response to determining that no machine-learning model was previously applied to the related multimedia file, applying a new set of one or more machine-learning models to the new multimedia file to identify one or more unique items of interest in the new multimedia file.

15. The system of claim 14, wherein the related multimedia file is a first multimedia file that captures an identical incident as the new multimedia file, or a second multimedia file in which at least a portion of the second multimedia file is captured within a predetermined distance of a geolocation at which at least a portion of the new multimedia file is captured.

16. The system of claim 14, wherein the actions further comprise:
applying the set of one or more machine-learning models to a multimedia file to identify a unique item of interest captured in the multimedia file;
presenting an image of the unique item of interest along with one or more corresponding images of at least one additional item of interest captured in the multimedia file that are identified by the set of one or more machine-learning models as being closest matches to the image of the unique item of interest;
receiving a user selection of at least one image of the one or more corresponding images as depicting the unique item of interest; and
storing item visual data that includes the image of the unique item of interest and the at least one image that is selected via the user selection,
wherein applying the set of one or more machine-learning models includes applying the set of one or more machine-learning models following training based on the item visual data to identify the unique item of interest in the new multimedia file.

17. The system of claim 14, wherein the actions further comprise:
receiving item label information for a unique item of interest captured in the related multimedia file; and
storing the item label information as metadata for the related multimedia file and the new multimedia file when the unique item of interest is identified in the new multimedia file.

18. The system of claim 14, wherein the actions further comprise applying an item tracking algorithm to the new multimedia file and the related multimedia file to track the unique item of interest in the new multimedia file and the related multimedia file.

19. The system of claim 14, wherein the actions further comprise at least one of:
storing, in an item link database, first metadata that links multiple unique items of interest that appear in the new multimedia file;
storing, in the item link database, second metadata that links multiple unique items of interest that appear in the new multimedia file and one or more related multimedia files;
storing, in the item link database, third metadata that links multiple multimedia files associated with multiple incidents when the multiple incidents are identified as being related incidents or associated with at least one common unique item of interest; or
storing, in the item link database, fourth metadata that links unique items of interest as captured in the multiple multimedia files associated with the related incidents.

20. A computer-implemented method, comprising:
receiving, at one or more computing devices, a new multimedia file that includes a plurality of video frames;
determining, via one or more computing devices, whether a set of one or more machine-learning models was previously applied to a related multimedia file to identify at least one unique item of interest in the related multimedia file;
in response to determining that the set of one or more machine-learning models was previously applied to the related multimedia file, applying the set of one or more machine-learning models to the plurality of video frames of the new multimedia file to at least identify the at least one unique item of interest in the new multimedia file; and
in response to determining that no machine-learning model was previously applied to the related multimedia file, applying a new set of one or more machine-learning models to the new multimedia file to identify one or more unique items of interest in the new multimedia file.
